(19) United States
(12) Patent Application Publication
(10) Pub. No.: US 2008/0267577 A1
(43) Pub. Date: Oct. 30, 2008

(54) INFORMATION PROCESSING APPARATUS

(75) Inventor: Kenji URITA, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 12/170,891

(22) Filed: Jul. 10, 2008

Related U.S. Application Data
(63) Continuation of application No. PCT/JP2006/300218, filed on Jan. 11, 2006.

(51) Int. Cl. H04N 5/91

(52) U.S. Cl. 386/46; 386/E05.001

(57) ABSTRACT

In an information processing apparatus, a recording unit is equipped for storing data. A judgment unit determines whether or not there is a spare capacity of no less than a predefined value in the recording unit for storing received data. If the judgment unit determines that there is no spare capacity of no less than the predefined value in the recording unit, a setup unit sets a value indicating the incapability of storing by way of a availability flag indicating the capability/incapability of storing data in the recording unit. A control unit controls the process for storing the data in the recording unit on the basis of the availability flag.

### CROSS REFERENCE TO RELATED APPLICATION

This application is a continuation of international PCT application No. PCT/JP2006/300218 filed on Jan. 11, 2006.

### BACKGROUND OF THE INVENTION

1. Field of the Invention

The present invention relates to a technique for storing video image data and the like in a recording apparatus and/or recording medium.

2. Description of the Related Art

Keeping pace with the development of network technologies such as the Internet, businesses distributing content such as video images and voice to terminal apparatuses have become increasingly popular. The content data that contains video images and voice has a large volume of data, and therefore, an attempt to receive the content by using a certain terminal apparatus is sometimes faced with a shortage of free space large enough to store the data in the terminal apparatus. If there is a shortage of free space in the recording apparatus or the recording medium of a terminal apparatus with which intends to receive the content, there are generally only two choices: giving up storing of the content or overwriting the space in the recording apparatus or the like in which other data is already stored in order to store the intended content.

To solve such a problem, there is technique provided for storing content in a device such as another terminal apparatus interconnected with a storage/terminal apparatus by way of a network, such as a local area network (LAN), in order to enable storing of the content without losing the already stored data in a recording apparatus even if a free space cannot be secured in the recording apparatus of the terminal apparatus in which the distributed content is intended to be stored (e.g., reference patent document 1, 2, and 3).

Patent document 1: Laid-Open Japanese Patent Application Publication No. 2002-359794

Patent document 2: Laid-Open Japanese Patent Application Publication No. 2003-308233

Patent document 3: Laid-Open Japanese Patent Application Publication No. 2004-158969

In the above described technique, the devices that are capable of storing the data of distributed content as a substitute storage and that are interconnected with a terminal apparatus by way of a network can comprehend not only recording apparatuses, such as a hard disk drive (HDD) recorder and a digital versatile disk (DVD) recorder, but also devices for further utilizing other than recording data, such as a personal computer (noted as “PC” hereinafter) comprising a recording apparatus. In a device comprising diverse functions, such as a PC, it is not appropriate to use the entire storage area for storing data, and it is preferable to have the capability to limit, to a predetermined capacity, the area to be used as the storage for the received data at the terminal apparatus.

The conventional technique, however, allows storing of content data in a storage area as long as the storage area remains in existence in a device connected to a network if there is a shortage of a storage area in the terminal apparatus that has received the distributed content regardless of a possibility that the recording apparatus may be used for purposes other than storing data, thus facing the problem that the storage area cannot be used for another intended use if so desired.

### SUMMARY OF THE INVENTION

In consideration of the situation described above, the present invention aims at providing a technique for enabling the judgment of the availability of storing data while securing an area allowing storage of data in each device when it is necessary to store the data in any of the devices constituting a network.

In order to solve the problem described above, an information processing apparatus according to the present invention includes a recording unit for storing data; a judgment unit for determining whether or not there is spare capacity in the recording unit for storing received data; a setup unit for setting availability information indicating the availability of storing data in the recording unit on the basis of a result determined by the judgment unit; and a control unit for controlling a processing for storing data in the recording unit on the basis of the capability/incapability information.

In each information processing apparatus, a pre-set value as the expected capacity sufficient for providing storage area for data and the actual free space are compared. If the free space is smaller than the predetermined value, a value is set to the availability information indicating that there is sufficient spare capacity allowed to provide for storing data. The control unit controls the availability of storing the data on the basis of the availability information, and thereby the availability of storing the data can be determined for each information processing apparatus.

Furthermore, the information processing apparatus according to the present invention may be configured such that the control unit stores, in the recording unit, data received by another information processing apparatus connected by way of a network if the availability information is set to indicate the capability of storing data.

Furthermore, it may be configured such that the setup unit sets availability information to indicate the incapability of storing data in the recording unit when it is detected that the spare capacity has become less than a predetermined capacity by the process for recording received data in another information processing apparatus, and the control unit stops recording data in the recording unit when the availability information is set to indicate the incapability of storing data during recording data. Alternatively, it may be configured such that the control unit refers to the availability information if there is an inquiry from the another information processing apparatus, about the capability/incapability of storing data, and the control unit reports to the other information processing apparatus a network address for the another information processing apparatus to transfer the data if the availability information is set to indicate the capability of storing data.

### BRIEF DESCRIPTION OF THE DRAWINGS

FIG. 1 is a diagram for describing the principle of the present invention;

FIG. 2 is the configuration diagram of an information processing apparatus according to the present embodiment;

FIG. 3 is a flow chart showing capacity monitor processing in a slave device;

FIG. 4 is a flow chart showing determination processing for determining an information processing apparatus for storing data between a master device and a slave device; and

FIG. 5 exemplifies an information table reported from a slave device to a master device.

### DESCRIPTION OF THE PREFERRED EMBODIMENTS

The following is a detailed description of the preferred embodiment of the present invention, referring to the accompanying drawings.

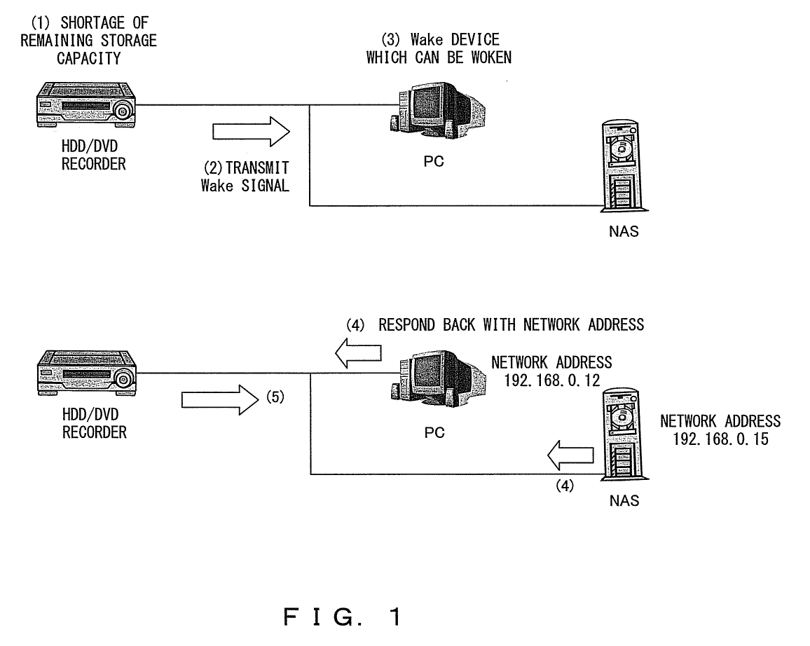

FIG. 1 is a diagram for describing the principle of the present invention.

A LAN system is made up by interconnecting a plurality of information processing apparatuses such as digital sound/image recording devices. FIG. 1 shows an HDD/DVD recorder, a PC, and a network-attached storage (NAS), as an example of a digital sound/image recording device. In the LAN system shown in FIG. 1, the HDD/DVD recorder is an information processing apparatus equipped with a function for accessing a discretionary server on, for example, a network such as the Internet and for receiving data distributed by way of the network. The PC and NAS are information processing apparatuses connected to the HDD/DVD recorder by way of the LAN.

Data that the HDD/DVD recorder receives includes data of a relatively large capacity, such as the program and content of, for example, a digital broadcast. If the volume of the received data is larger than the spare capacity of the recording apparatus of an information processing apparatus receiving data, i.e., the recording apparatus of the HDD/DVD recorder, it is referred the possibility of recording data in another information processing apparatus (i.e., a PC or a NAS) making up a LAN system to determine which of the information processing apparatuses that make up the LAN system stores the data. The data is stored in an appropriate information processing apparatus, as a substitute, from among those information processing apparatuses on the basis of the reference result. Paragraph numbers (1) through (5) noted in FIG. 1 indicate the procedure for storing the data. Next is an outlined description of the method for determining the storage destination of data in the information processing apparatus according to the present invention referred to in FIG. 1.

To begin with, (1): a HDD/DVD recorder, which is intended to be used for accessing a discretionary server on a network and receiving a distribution service of the content, recognizes that there is no spare capacity large enough to store the content, (2): the HDD/DVD recorder transmits a “wake” command to all other information processing apparatuses connected by way of a LAN. Here, the wake command is a command for canceling sleep state of the other information processing apparatuses, each of which has received a prescribed packet transmitted by way of the LAN. The wake command is transmitted to all the other information processing apparatuses making up the LAN system, that is, the PC and NAS in the example of FIG. 1. Since the wake command is a known art, the description is not provided herein in detail. (3): Having received the wake command, the other information processing apparatuses (such as the PC and NAS) carry out the initiation process of respective systems if they have been in the sleep states.

Having been initiated if they had been in the sleep state, (4): the PC and NAS determine whether or not they have respective spare capacities large enough to store data and, if the result is that they do, return information, such as the capacity that can be provided for storing data and the network address to the HDD/DVD recorder. (5): The HDD/DVD recorder determines which of the information processing apparatuses (i.e., the PC or NAS) is made to store data in on the basis of the information received from the PC and/or NAS, and it transfers the data to the determined information processing apparatus (i.e., the PC or NAS). As for the information processing apparatus (i.e., the PC or NAS) that will be unused for storing the data, the HDD/DVD recorder transmits a “sleep” command to the information processing apparatus (es) that had been in the sleep state when the wake command was received, thereby returning it, or them, to the sleep state. Note that it does not send the sleep command to the information processing apparatus (es) that had been in operation.

The PC and NAS determine whether or not data can be stored in the recording apparatus preliminarily and retain the judgment result as information. If it is determined (i.e., the PC and NAS) that the area required for storing the data received at the HDD/DVD recorder cannot be secured therein, the PC or NAS refers to the information indicating the presence or absence of a spare capacity respectively and returns a response to the HDD/DVD recorder indicating the capability of storing if the content can be stored in the PC or NAS. The HDD/DVD recorder selects the most optimal information processing apparatus from among the apparatuses thereof that have returned the responses and designates it as the storage destination of the content.

Incidentally, the “operation” state described above represents the state in which the power supply of a sound/video recording device or the like is turned on, while the “sleep” state represents the state in which the power is turned off, that is, the recording device is ready and waiting for receiving an instruction for an initiation process from a user or the like.

In the embodiment described hereafter, in FIG. 1 as an example, the information processing apparatus such as the HDD/DVD recorder, which receives data by way of the Internet or the like, is defined as a master device while the information processing apparatuses such as the PC and NAS, which store data in the recording apparatuses comprised by the respective information processing apparatuses as needed basis and as instructed from the master device, are defined as slave devices.

The master devices include, for example, an HDD/DVD/VHS (video home system) recorder, an HDD recorder, a DVD recorder, a PC, and a network music server, in addition to the HDD/DVD recorder shown in FIG. 1. The slave devices include the NAS and the like that are shown in FIG. 1, in addition to the information processing apparatuses similar to the master devices.

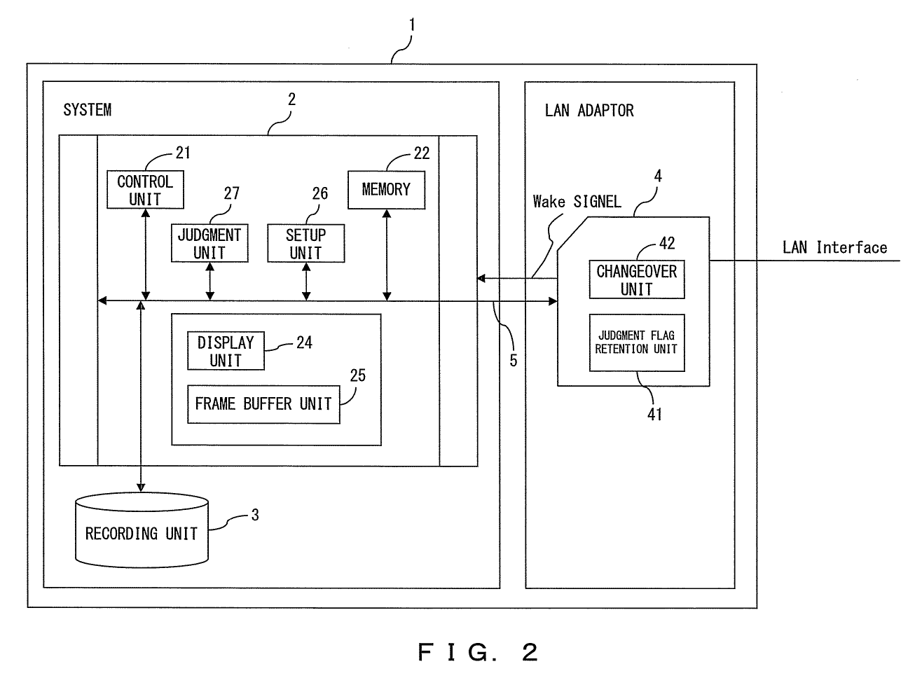

FIG. 2 is the configuration diagram of an information processing apparatus according to the present embodiment.

The configuration of the apparatus shown in FIG. 2 is common for the master and slave devices and shows only comprisals related to the above described method for determining the storage destination of data.

The information processing apparatus 1 according to the present embodiment comprises a system control unit 2, a recording unit 3, and a network adaptor 4, the entirety of which are interconnected via a bus 5. The function of the system control unit 2 is implemented by the operating system and the like of the information processing apparatus 1, and the function of the network adaptor 4 is installed in the controller chip of a LAN board. The recording unit 3, being, for example, a recording apparatus such as a hard disk drive and the like of the information processing apparatus 1, includes an external recording apparatus such as a DVD in the following description.

The system control unit 2 comprises a control unit 21, memory 22, a display unit 24, a frame buffer unit 25, a setup unit 26 and a judgment unit 27, with the individual components within the system control unit 2 being also interconnected by way of the bus 5. The control unit 21 controls various processing related to storing data such as content on the basis of the spare capacity of the recording unit 3, with the function of the control being executed by a central processing unit (CPU) executing a prescribed program. The memory 22, which is specifically constituted by read only memory (ROM) and random access memory (RAM), stores a program executed at the control unit 21 and information necessary for a control. The judgment unit 27 determines whether or not the capacity of the recording unit 3 allowed to be used for storing data such as content is no less than a predefined value. The setup unit 26 sets a value indicating the capability/incapability of storing the data on the basis of the judgment result of the judgment unit 27.

The display unit 24 is a means for displaying the processing state and processing result of the information processing apparatus 1, and the unit comprises a display part for displaying the state of the information processing apparatus 1 by using, for example, a diode and, in addition, a monitor or the like. The frame buffer unit 25 is a memory area for retaining image data. Note that the display unit 24 and frame buffer unit 25 are appropriately equipped in the individual information processing apparatuses 1.

The network adaptor 4 comprises a judgment flag retention unit 41 and a changeover unit 42. The judgment flag retention unit 41 stores a flag for retaining, on the LAN adaptor side (i.e., on the network adaptor 4 side), the result of the determination by the system side (i.e., on the system control unit 2 side) as to whether or not the recording unit 3 is capable of storing data. When the information processing apparatus 1 receives a wake command while it is in the sleep state, the changeover unit 42 transmits the wake signal to the system side and makes the information processing apparatus 1 carry out an initiation process.

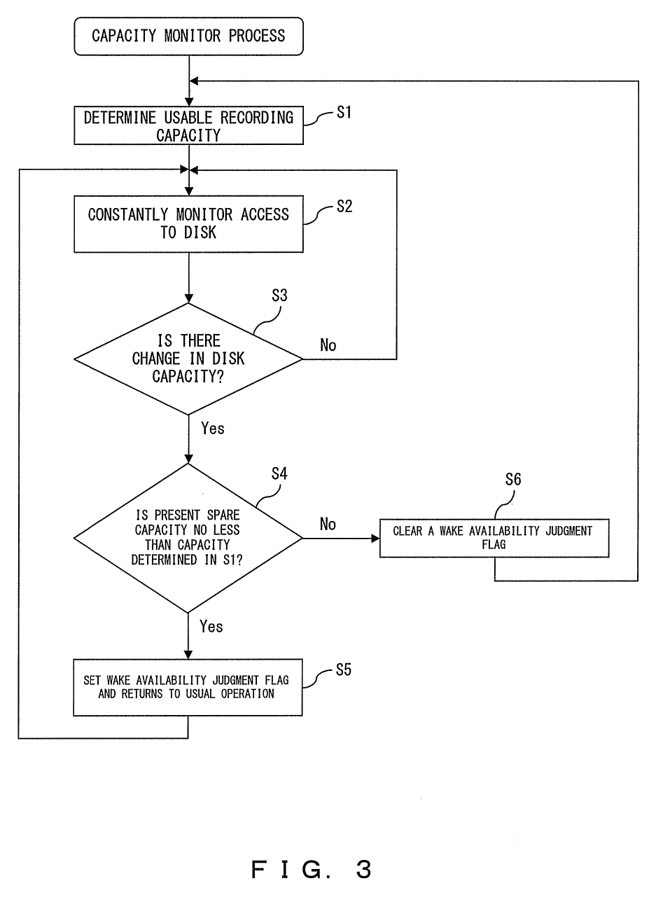

FIG. 3 is a flow chart showing capacity monitor processing in a slave device.

The capacity monitor processing shown in FIG. 3 is started at a prescribed timing such as the initiation or the like of a slave device.

First, in step S1, a utilizable recording capacity for storing data, such as content received at a master device, is determined. As an example, a condition, “within 100 gigabytes and within 50% of the capacity of the entire recording unit 3”, is set for each slave device. This utilizable recording capacity may be preassigned in a slave device or determined by the user of the slave device. Alternatively, it may be configured to be set up by a network administrator.

Then, in step S2, an access to the disk (i.e., the recording unit 3) is constantly-monitored, and, in step S3, if there is a change in the capacity of the disk, the process proceeds to S4. The access in this event represents the access to the recording unit 3 related to various kinds of information processing within the slave device such as the process for storing the execution result of various applications and that for deleting data in the slave device.

In step S4, whether or not a post-change spare capacity of the disk satisfies the condition determined in step S1 is determined. If the condition of step S1 is still satisfied after the access to the disk, the process proceeds to step S5, and in step S5, a flag is set to “1” which indicates permission to store data transferred from the slave device to master device, and the process returns to the monitoring operation of step S2. Here, the flag indicating the availability of storing data transferred from the master device is defined as a wake availability judgment flag. The wake availability judgment flag is referred to, in response to the wake command transmitted from the master device, for each slave device determining whether or not data can be stored. In the present embodiment, if the wake availability flag is set to “1”, it indicates that there is an availability of storing data in the disk of the slave device, while if the flag is set to “0”, it indicates that there is no availability of storing data in the slave device.

If it is determined that the capacity no longer satisfies the condition determined in S1 after accessing the disk in step S4, the process proceeds to step S6 in which the flag above mentioned is set to “0”. A value indicating the incapability of storing the data in the disk is set to the wake availability judgment flag, and then the process returns to step S1, in which a condition, such as the capacity usable to store content data and the like, is set again.

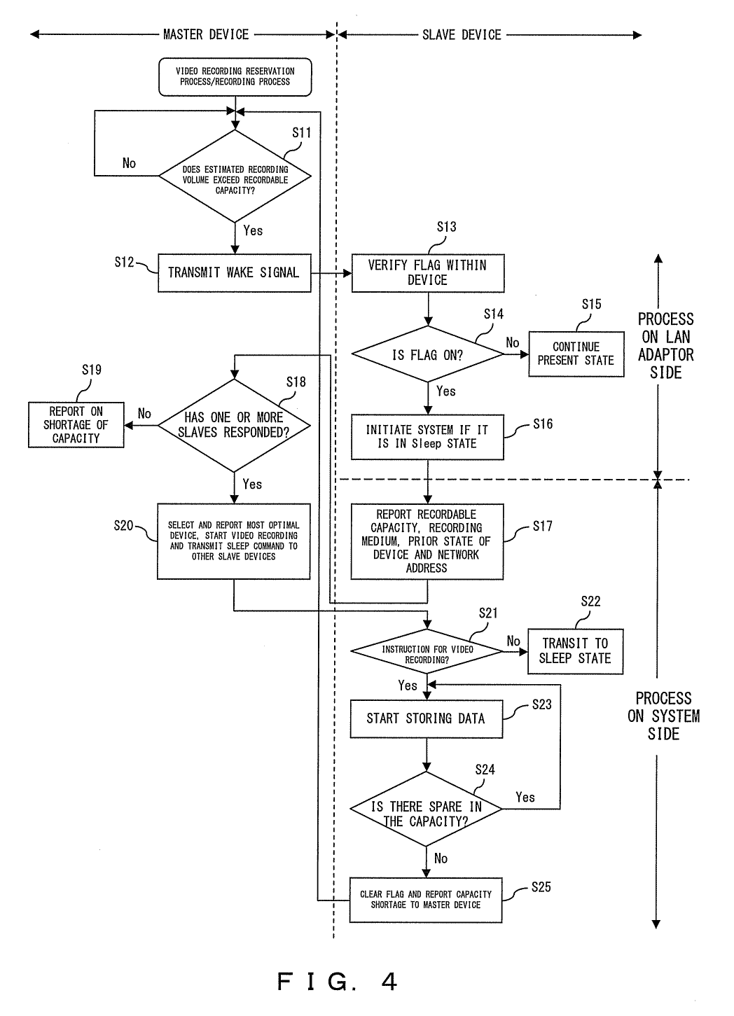

FIG. 4 is a flow chart showing determination processing for determining an information processing apparatus for storing data between a master device and a slave device.

The determination processing shown in FIG. 4 is started at the time when a video recording of data such as content at a master device is being reserved or at a predetermined time during which the process of video recording is being carried out. Further, a wake availability judgment flag is pre-set in each slave device by way of the capacity monitor process shown in the above described FIG. 3.

First, in step S11, it is determined whether or not there is a spare capacity sufficient for storing content data at the master device; that is, the volume of the content intended to be recorded is estimated and whether or not the estimated volume exceeds a recordable spare capacity is determined. If the volume of the content is decided to be exceeding the recordable spare capacity, the process proceeds to step S12. The master device transmits a wake command to all slave devices connected by way of the LAN in step S12.

In step S13, having received the wake command transmitted from the master device, each slave device refers to the value of the wake availability judgment flag. In step S14, it is determined whether or not the flag is on, that is, it is determined whether or not the value of the wake availability judgment flag is set to “1”, in the present embodiment. A slave device in which the wake availability judgment flag is set to “0” and in which it is determined that there is no spare capacity sufficient to provide for storing the content in the recording unit 3 proceeds to step S15 and sends no response back to the master device. In contrast, a slave device in which the wake availability judgment flag is set to “1” and which is to be capable of letting the recording unit 3 use the device for storing the content proceeds to step S16 and initiates the system if the slave device itself has been in the sleep state in accordance with the wake event. A slave device that has been in operation proceeds to step S17 without carrying out any particular processing.

In step S17, the slave device reports information such as a recordable capacity and a network address to the master device. The information reported by each slave device to the master device in step S17 is the information to be used for reporting, to the master device, information necessary for the master device to determine a slave device to store the content and transfer the data to the slave device, and necessary for the master device to return another slave device(s) to the state in which the device(s) had been before the transmission of the wake command.

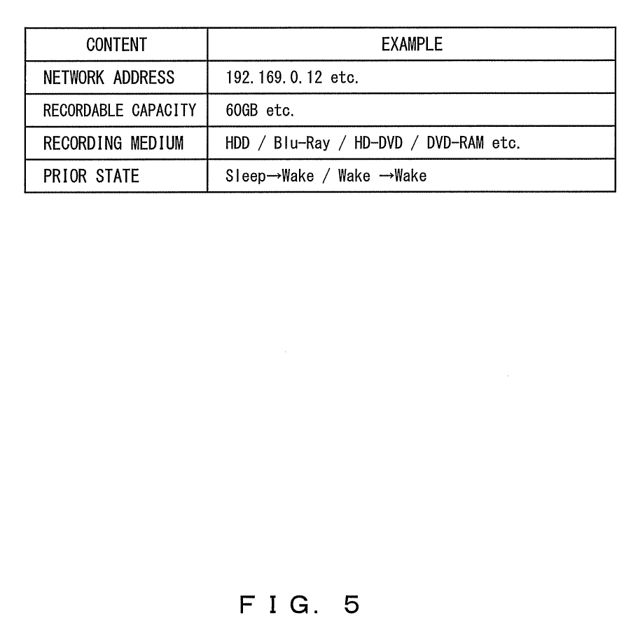

FIG. 5 exemplifies an information table reported from a slave device to a master device.

Information reported to the master device includes, for example, a network address, recordable capacity, a recording medium, and the prior state of a slave device as shown in FIG. 5.

The network address is the data for identifying each slave device on a network, such as an Internet protocol (IP) address. The recordable capacity is the spare capacity of the recording unit 3 that can be spared for providing storage of content and the like. The recording medium is the information on the kinds of recording media, for example, HDD, Blu-ray disk, HD-DVD, DVD-RAM, and the like. The prior state includes information such as that which indicates being in the sleep state, in operation or such, when the wake command sent from the master device in step S12 (refer to FIG. 4) has been received. In the example of FIG. 5, either “sleep to wake” or “wake to wake” is stored in “the prior state”, meaning that the prior state is either the sleep state or operating state respectively.

Returning to the description of FIG. 4, when the master device receives the information such as recordable capacity and a network address reported from the slave device in step S17, the master device determines whether or not one or more slave devices have responded to the wake command in step S18. If none of the slave devices has responded, it decides that there is no device capable of storing the content, and the process turns to step S19, in which the shortage of capacity is notified to the user, and ends the process. In contrast, if there has been a response from at least one slave device, the process turns to step S20.

In step S20, the master device selects, from among the slave devices which have responded, the most optimal slave device for storing the content and starts the process, for the selected slave device, related to the recording of the content data. In addition, the master device transmits a sleep command to the slave device that had been in the sleep state when receiving the wake command, and the master device does not transmit any command to a slave device that had been in the operating state when receiving the wake command.

The slave device, which has received the command or data from the master device, determines whether or not the received information is an instruction to record content in step S21. If it is not an instruction to record, that is, if a sleep command has been received, the slave device transits to the sleep state according to the received sleep command in step S22 and ends the process. If an instruction for recording has been received, the process turns to step S23. Incidentally, a slave device that is not the target of receiving the instruction for recording and that had not been in the sleep state when receiving the wake command receives neither a recording instruction command nor a sleep command.

In step S23, the slave device that is the data storage location starts storing the data. In step S24, it is determined free space, and it repeats the processes of steps S23 and S24 until the condition determined in step S1 (refer to FIG. 3) is no longer satisfied. If the free space is determined to be in shortage at the slave device in which the recording is performed, the process proceeds to step S25. When the wake availability judgment flag is set to “0” and a capacity shortage is reported to the master device in step S25, the process returns to the process of step S11. What follows hereafter is the repeated execution of the above described determination process until the end of the video recording process.

The above described determination process may be configured to determine whether or not there is a shortage of capacity in the recording apparatus of the master device by roughly calculating the data volume before starting a recording process, or to store data in the master device until the capacity in the recording apparatus of the master device becomes no more than the above described recordable capacity and then to switch to a slave device (i.e., a “relay recording”) in the middle of the data when a shortage of capacity occurs in the master device. In the case of carrying out a relay recording from the master device to slave device, it is preferable to also store the information of a slave device as the relay destination and that of the storing file in a file related to the data storing in the master device. This configuration makes it possible to transmit a wake command to the slave device storing data by itself and carry out a relay replay without any operation of the user when replaying, for example, the recorded data.

Further, the process for selecting the slave processing for storing the data in step S20 may be configured to select the process on the basis of, for example, the size of a spare capacity; or to select it on the basis of the data recording rate of the recording apparatus comprised by an individual slave device, the access speed to the master device or another parameter.

As described above, the information processing apparatus (i.e., the master device and slave device) according to the present embodiment is configured to monitor the capacity of the recording apparatus at an individual information processing apparatus and to retain the information of the availability of storing data in the wake availability judgment flag. The capacity that can be provided for storing data is set to each information processing apparatus in accordance with the environment and usage purpose thereof. This configuration makes it possible to determine the capability/incapability of storing data appropriately for the individual information processing apparatuses constituting a LAN system.

Note that the above described embodiment is described by exemplifying the timing of receiving a wake command as the timing for a slave device to return the information shown in FIG. 5, such as a network address and the capacity, to the master device; it is only discretionary. An individual slave device always retains the information as to whether or not the slave device itself has the capacity allowed to provide for storing data, in place of the master device in which the data cannot be stored due to the shortage of capacity, and that can obtain a benefit similar to the above description by communicating between the master device and slave device at the time when a shortage of capacity is recognized in the master device or when the capability of storing data is determined from a slave device.

Meanwhile, it is also possible to apply the above described method to a certain information processing apparatus, and the like, comprising a plurality of storage apparatuses. For example, if a spare capacity sufficient to store data to be saved is determined to be non-existent in a certain storage apparatus that is set to store data by default, it is possible to retain the information of the capability/incapability of storing the data in other storage apparatuses preliminarily, determine which of the storage apparatuses to store the data in on the basis of the information, and to store the data in the storage apparatus.

The above described embodiment is contrived to enable a comparison between a predetermined value and spare capacity, which are provided for each information processing apparatus, and to enable the determination of the availability of storing data in the information processing apparatus.

What is claimed is:

1. An information processing apparatus, comprising:
a recording unit storing data;
a judgment unit determining whether or not there is a spare capacity in the recording unit for storing received data;
a setup unit setting availability information indicating the availability of storing data in the recording unit on the basis of a result determined by the judgment unit; and
a control unit controlling the process for storing data in the recording unit on the basis of the availability information.

2. The information processing apparatus according to claim 1, wherein
said control unit stores, in said recording unit, data received by another information processing apparatus connected by way of a network if said availability information is set to indicate the capability of storing data.

3. The information processing apparatus according to claim 2, wherein
said setup unit sets availability information to indicate the incapability of storing data in said recording unit when it is detected that said spare capacity has become less than a predetermined capacity by the process for recording received data in the another information processing apparatus, and
said control unit stops recording data in the recording unit when said availability information is set to indicate the incapability of storing data during the period of data recording.

4. The information processing apparatus according to claim 2, wherein
said control unit refers to said availability information if there is an inquiry from the another information processing apparatus about the capability/incapability of storing data, and
the control unit reports, to the other information processing apparatus, a network address for the another information processing apparatus to transfer the data if the availability information is set to indicate the capability of storing data.

5. The information processing apparatus according to claim 4, further comprising
a changeover unit changing over a power source from off-state to on-state if there is said inquiry, wherein
the changeover unit changes over the power source, which has been turned to on-state, to off-state at a timing instructed by the another information processing apparatus on the basis of said network address, if data received by the another information processing apparatus will not be stored in said recording unit.

6. An information processing system comprising a plurality of information processing apparatuses, wherein
each information processing apparatus comprises
a recording unit storing data;
a judgment unit determining whether or not there is a spare capacity in the recording unit for storing received data;
a setup unit setting availability information indicating the availability of storing data in the recording unit on the basis of a result determined by the judgment unit; and
a control unit controlling the process for storing data in the recording unit on the basis of the availability information, wherein
one information processing apparatus of the plurality thereof further comprises
a reception unit receiving data by way of a network, and
a selection unit referring to the availability information of the plurality of information processing apparatuses and selecting an information processing apparatus for storing data received at the reception unit.

7. A recording medium containing a program for causing a computer to perform information processing method, said method comprising:
determining whether or not there is a spare capacity in a recording unit provided for storing the data for storing received data;
setting availability information indicating the availability of storing data in the recording unit on the basis of the judgment result; and
controlling the process for storing data in the recording unit on the basis of the availability information.
